(19) United States
(12) Patent Application Publication
(10) Pub. No.: US 2006/0241225 A1
(43) Pub. Date: Oct. 26, 2006

(54) Laser activated thermochromic compositions

(76) Inventors: Yan Bielek, Cumberland, RI (US); Eric Barker, Longmeadow, MA (US)

Correspondence Address: Attn: Maurice E Gauthier;Gauthier & Connors, LLP, Suite 3300, 225 Franklin Street, Boston, MA, 02110, US

(21) Appl. No.: 11/406,974

(22) Filed: Apr. 19, 2006

Related U.S. Application Data
(60) Provisional application No. 60/673,191, filed on Apr. 20, 2005.

(51) Int. Cl. C08K 5/00

(52) U.S. Cl. 524/284

(57) ABSTRACT

A thermochromic composition comprises, a binder polymer, a thermochromic dye and a stabilizer. The composition is responsive to exposure to a laser beam by undergoing an irreversible color change.

### CROSS REFERENCE TO RELATED APPLICATION

This application claims priority from Provisional Patent Application Ser. No. 60/673,191 filed Apr. 20, 2005.

### BACKGROUND OF THE INVENTION

1. Field of the Invention

This invention relates generally to thermochromic compositions, and especially to thin films and coatings of such compositions that undergo an irreversible color change when heated by laser energy.

2. Description of the Prior Art

As herein employed, the term “pixel” means the area exposed to a stationary laser beam; “thermochromic” material or composition means one that partially decomposes and undergoes an irreversible color change when heated to a threshold reaction temperature; and “stabilizer” means a radical trap that prevents the complete and colorless decomposition of a thermochromic material when exposed to a laser beam, and instead allows for a controlled partial decomposition of the material to a color altered state.

Thermochromic materials are known, as disclosed for example in U.S. Pat. Nos. 4,344,909 and 4,450,023 (both issued to DeBlauwe), the descriptions of which are herein incorporated by reference. Such thermochromic materials are conventionally heated to their reaction temperatures by various means, including for example, exposure to heated environments in ovens or the like, contact by heated platens or probes, etc. However, efforts to achieve color changes by exposure of these thermochromic materials to laser beams have been unsuccessful, thus thwarting attempts to employ such materials in high speed applications, e.g. recordation of data.

Without being limited to any particular theory, it is believed that this failure to achieve the desired irreversible color change is due to a complete and colorless decomposition of the colored reaction product of the thermochromic material as a result of the combination of the high temperature and high energy dose delivered by the laser.

### SUMMARY OF THE INVENTION

The present invention stems from the discovery that laser activated color formation of a composition containing a thermochromic material is made possible by the addition of a stabilizer to the composition.

### DETAILED DESCRIPTION

A thermochromic composition in accordance with the present invention comprises a binder polymer, a thermochromic dye, a stabilizer, and optionally a solvent.

Examples of potentially useful thermochromic dyes are listed in the following Table:

TABLE

| | |
|---|---|
| 1,2-Benzoquinone | α-lactose |
| Citraconic acid | 3-amino-1-phenyl-pyrazolone |
| Azobisisobutyronitrile | 4-amino-3-hydroxy-butyric acid |
| Fructose | 4-amino-3-hydrazino-5-mercapto-1,2,4- |
| Methyl yellow | triazole |
| 2,3-benzoxazin-1-one | Allantoin |
| Formamidine sulfinic acid | Imino-diacetic acid |
| D(+) Maltose | Dimethylglyoxime |
| Malonic acid | Oxalic acid dihydrazide |
| 1,3-acetonedicarboxylic acid | Ethylene diamino tetra acetic acid |
| 4-aminosalicylic acid | Glycine |
| 5-anilino-1,2,3,4-thiatriazole | Hesperidin |
| 1-phenyl-5-mercapto-tetrazole | Barbituric acid |
| Formamidine acetate | Nicotinic acid-N-oxide |
| D(+)-galactose | Phenyl-2-piperidyl-acetic acid |
| d(−)-tartaric acid | Succinamide |
| Aminoguanidine bicarbonate | DL-phenylalanine |
| Oxytetracycline | 5-amino-salicylic acid |
| Chinolinic acid | DI-methionine |
| Sucrose | DL-alanine |
| Ascorbic acid | N-hydroxyethyl ethylenediamine |
| Methylene blue | triacetic acid trisodium salt |
| 2-hydroxy-1,4-dinaftoguinone | dihydrate |
| 2-methyl-3-indolylacetic acid | Creatine |
| Guanidinecarbonate | 2-amino octanic acid |
| P-aminophenylacetic acid | Maleic acid dihydrazide |
| 5-amino-tetrazole monohydrate | Nile blue |
| β-alanine | 2-hydroxy-benzimidazole |
| L-glutamic acid | 1,4-benzenedicarboxylic acid |
| Methyl violet | Dinicotinic acid |
| L-lysine | 4,4-azobenzenedicarboxylic acid |
| 2,4-dihydroxybenzoic acid | 6-uracilcarboxylic acid |
| 4-hydrazinobenzoic acid | Melamine |
| Azodicarbonamide | Guanine |
| | Oxamide |

Various colors and image stabilities can be obtained by the appropriate choice of the above thermochromic dyes, and combinations thereof, and stabilizer. The polymeric binder imparts various levels of control over abrasion, temperature, UV, moisture, and other environmental influences. The polymeric binder is also of importance when the substrate is a polymeric film.

The use of a stabilizer in the form of a radical trap, preferably a radical trap that is also a Lewis Acid, has been found to be critical for marking thermochromic compositions with a laser. Lewis acids may be selected from the group consisting of boric acid, oxalic acid, salicylic acid and di or tri-proto-phosphates. Other useful radical traps include mono-proto-phosphates, hindered amines, and organo-metallics such as tetra-alkyl tin compounds.

The stabilizer comprises between 10% and 90% by weight of the thermochromic dye and the stabilizer. The binder polymer comprises between 10% and 90% by weight of the binder polymer, thermochromic dye and stabilizer.

Adhesion concerns will often dictate the choice of the binder polymer. Polyesters, acrylics, vinyl co-polymers, styrenics, polyurethanes, polyamides, polyolefins and cellulosics, would, in the context of a specific application (film, paper, environmental resistance required, etc), be appropriate choices as binders. The binder can be chosen to serve not only as a carrier of the thermochromic composition, but also as a compatible ink receptive surface to accommodate other printing technologies. Thus, by appropriate selection of a binder, a coating or film may display printed data, and also undergo a laser activated color change.

The thermochromic dye and stabilizer also can be incorporated in an extrudate with the extrudate serving as both the carrier and the binder. The amount of thermochromic dye/stabilizer in the extrudate can range between 0.01% and 60% by weight. Extrusion processing temperatures must not exceed the threshold reaction temperature of the thermochromic dye/stabilizer combination.

Materials such as, but not limited to, polyesters, acrylics, vinyl co-polymers, styrenics, polyurethanes, polyamides, polyolefins are useful extrusion candidates.

It should be noted, however, that the material choice for the layer containing the thermochromic dye/stabilizer should not preferentially absorb laser energy. For example, polymers such as polypropylene and polyethylene are more transparent to CO₂ lasers than, for example, polyethylene terephthalate. Thus, in a multilayer film composite, the layer containing the thermochromic dye/stabilizer combination should either be on top, or beneath one or more layers which are as transparent to the laser. Subsequent layers will have little influence on laser marking. As is known in the art, additives that preferentially absorb radiant energy from a laser can be incorporated to more effectively deliver the heat to the thermochromic dye/stabilizer system.

It has also been determined that the addition of nanoparticles (1 to 500 nanometers) can improve the stability of the coating by forming protective colloids and/or controlling the rheology. Improvements in color development and pixel resolution during marking can result. Further, these nanoparticles can alter other physical/mechanical properties including but not limited to flexibility, abrasion resistance, stability of thermochromic dye and others. Examples of useful nanoparticles include silicon oxide, antimony oxide, titanium oxide and aluminum oxide. The nanoparticles can be from 0.01 to 20%, and preferably between 1.0 to 4.0% by weight of the thermochromic composition.

The following examples are illustrative of the present invention:

### EXAMPLE 1

A coated test film was prepared and exposed to laser energy as follows:

Laser used, S200 from Domino Amjet (1290 Lakeside Drive, Gurnee, Ill. 60031), with the laser on (CO₂) at 200 μs and energy output range of 5 to 20 W.

| | |
|---|---|
| Solvents (blend of MEK and toluene 50% Toluene, 50% MEK | 75.7 parts |
| by weight) | |
| Binder polymer from the polyester family, Dynapol ® | 16.2 parts |
| S 1606 sold by: Degussa Corp./Creanova Inc. | |
| Parsippany, NJ USA | |
| Thermochromic Dye, ascorbic acid | 8.1 parts |

Substrate:

A white 200 gauge Mylar® from DuPont Teijin Films, Hopewell, Va., USA.

The above coating was drawn down with a Meyer drawdown bar #16, dried at 70° C. for 1 minute and then subjected to a test pattern of indicia from the above described laser.

Results: No discernable indicia pattern on the test film over a laser character speed of 1000 bits per millisecond to 9000 bits per millisecond.

The same material when heated with a hot air gun or placed in an oven at 200° for 15 to 60 seconds, resulted in a change from off white to an overall orange/brown coloration.

### EXAMPLE 2

A coated test film was prepared in accordance with Example 1, with the addition to the coating composition of a stabilizer comprising 8.1 parts boric acid. When exposed to laser energy in accordance with Example 1, clearly formed indicia resulted.

### EXAMPLE 3

A coated test film was prepared in accordance with the following:

| | |
|---|---|
| Solvents (blend of MEK and toluene 50% Toluene, 50% MEK | 75.7 parts |
| by weight) | |
| Binder polymer from the polyester family, Dynapol ® | 16.2 parts |
| S 1606 sold by: Degussa Corp./Creanova Inc. | |
| Parsippany, NJ USA | |
| Thermochromic Dye, ascorbic acid | 1.1 parts |
| Stabilizer- boric acid | 15.0 parts |

Substrate:

A white 200 gauge Mylar® from DuPont Teijin Films, Hopewell, Va., USA.

When exposed to laser energy in accordance with Example 1, a slight color change was effected, resulting in the formation of faint indicia at the threshold limit of visibility, with unacceptably low contrast against the white background.

### EXAMPLE 4

A coated test film was prepared in accordance with the following:

| | |
|---|---|
| Solvents (blend of MEK and toluene 50% Toluene, 50% MEK | 75.7 parts |
| by weight) | |
| Binder polymer from the polyester family, Dynapol ® | 16.2 parts |
| S 1606 sold by: Degussa Corp./Creanova Inc. | |
| Parsippany, NJ USA | |
| Thermochromic Dye, ascorbic acid | 15.1 parts |
| Stabilizer- boric acid | 1.2 parts |

Substrate:

A white 200 gauge Mylar® from DuPont Teijin Films, Hopewell, Va., USA.

When exposed to laser energy, a slight color change comparable to that of Example 3 was effected.

### EXAMPLE 5

Using the coating formulation of Example 2, it was found that there was a tendency for particulates to settle and separate almost immediately after stirring was discontinued. This would make it extremely difficult to produce an even coating in a production situation. To address this problem, the formulation was modified by the addition of 2 parts of a nanoparticle, Wacker HDK H15 available from Wacker Silicones Corporation, Adrian, Mich.

This prevented settling and dramatically reduced separation, allowing at least an 8-hour post-mixing pot life. Further, after a longer period on the order of two weeks, when minimal separation occurred, simple stirring quickly and easily returned the mixture to its prior stable state for coating.

The addition of laser (frequency specific) dyes can also facilitate laser absorption efficiencies, thus increasing marking speed and/or compensating for the binder or film's filtering of the laser energy.

The toluene/MEK blend as used in the above examples is not the only choice for the liquid phase. The requirement is that the solvent must dissolve the binder polymer. Thus, organic solvents such as alcohols, ketones, esters, aromatic or aliphatic or halogenated hydrocarbons, and non-organic solvents such as water would have utility in this invention.

Further, the range of solvent concentration to the thermochromic agent and stabilizer will vary as a function of the desired coating viscosity. Ranges of solvent concentration between 10% and 90% are useful, with concentrations in the range 50% to 80% by weight being preferable.

Thermochromic compositions incorporating stabilizers in accordance with the present invention are particularly useful in the form of films and coatings having thicknesses of less than about 600 μm. Thicknesses of less than 100 μm are advantageous, with thicknesses of between about 10-25 μm being preferable, and with thicknesses of less than about 5 μm being most preferable. Irreversible color changes are achievable by exposure to laser energy for less than 1 second, and preferably less than 0.01 second per pixel.

In light of the forgoing, it will now be appreciated by those skilled in the art that thermochromatic compositions in accordance with the present invention may be applied to substrates as coatings of varying thicknesses, with thin coatings of less than 5 μm being most preferable. Substrates may be flood coated with a continuous layer, zone coated with continuous separate lanes, or printed with discrete patches or images. Thermochromic compositions of the present invention may also comprise extrudates, applied as coatings on substrates, or as films to be adhered or transferred onto substrates.

Coated or layered thermochromic compositions in accordance with the present invention may be protected by clear layers. This may be achieved, for example, by coating the thermochromic layer on the underside of a clear film, by overlaminating the thermochromic layer with a clear film, or by applying a clear protective coating, e.g. a varnish or the like. Clear films may be applied or incorporated by various methods as long as threshold temperatures for the thermochromic dyes are not achieved. Such methods may include the use of thermal and pressure activated adhesives as well as thermal and radiation cured coatings or coatings that are phase separated from the thermochromic layer during drying or curing. When applied after the laser image has been created, the clear protective layers may preferably be comprised of materials that hinder the transmission of subsequent laser exposure, thus protecting the original image from being altered.

Thermochromic compositions in accordance with the present invention may also by incorporated as unique identifying markers, e.g., sequential numbering, to prevent optical security devices from being copied without the laser sensitive identifying marker being visible in the copy. An example of one such use is the application of a thermochromic coating as an identifying marker on the profiled underside of a hologram.

Thermochromic compositions in accordance with the present invention are also useful in high speed laser activated non-contact cancellation applications, such as for example the cancellation of postage stamps, tickets, etc.

Thermochromic coatings of the present invention may be applied to three dimensionally curved surfaces of bottles, tubes, batteries, and the like to provide laser responsive high resolution markings.

We claim:

1. A thermochromic composition comprising, a binder polymer, a thermochromic dye and a stabilizer, said composition being responsive to exposure to a laser beam by undergoing an irreversible color change.

2. The thermochromic composition of claim 1 further comprising a solvent.

3. The thermochromic composition of claim 2, wherein said solvent is selected from the group consisting of alcohols, ketones, esters, aromatic or aliphatic or halogenated hydrocarbons and water.

4. The thermochromic composition of claim 1 wherein said stabilizer is a Lewis acid.

5. The thermochromic composition of claim 1, wherein said stabilizer is selected from the group consisting of boric acid, oxalic acid, salicylic acid and mono, di, or tri-proto-phosphates, hindered amines, and organo-metallics including tetra-altyltin compounds.

6. The thermochromic composition of claim 1, wherein said thermochromic dye is selected from the group consisting of those listed in the Table of the present specification, and combinations thereof.

7. The thermochromic composition of claim 1, wherein said binder polymer is selected from the group consisting of polyesters, acrylics, vinyl co-polymers, styrenics, polyurethanes, polyamides and polyolefins.

8. The thermochromic composition of claim 1, further comprising nanoparticles.

9. A polymeric film comprising a solvent, a binder polymer, a thennochromic dye and a stabilizer, said film being responsive to exposure to a laser beam by undergoing an irreversible color change.

10. A composite comprising at least two layers, at least one layer comprising a solvent, a binder polymer, a thermochromic dye and a stabilizer, said composite being responsive to exposure to a laser beam by undergoing an irreversible color change.

11. The thermochromic composition of claim 1 further comprising an agent for controlling rheology.

12. The thermochromic composition of claim 1, wherein said stabilizer comprises between 10% and 90% by weight of said thermochromic dye and said stabilizer.

13. The thermochromic composition of claim 1 wherein the binder polymer comprises between 10% and 90% by weight of said binder polymer, said thermochromic dye and said stabilizer.

14. The thermochromic composition of claim 8 wherein said nanoparticles are selected from the group consisting of silicon oxide, antimony oxide, titanium oxide and aluminum oxide.

15. The thermochromic composition of claim 8 wherein said nanoparticles comprise between 0.01% and 20% by weight of said thermochromic composition.

16. The thermochromic composition of claim 15 wherein said nanoparticles comprise between 1.0 to 4.0% by weight of said thermochromic composition.

17. The thermochromic material of claim 1, wherein the exposure to said laser beam is less than 1 second per pixel.

18. The thermochromic composition of claim 17, wherein said exposure is less than 0.01 seconds per pixel.

19. The thermochromic composition of claim 2 wherein the range of solvent concentration to the thermochromic agent and stabilizer is between 10% and 90% by weight.

20. The thermochromic composition of claim 19 wherein the range of solvent concentration to the thermochromic agent and stabilizer is between 50% and 80% by weight.

21. The composite of claim 10 wherein the said one layer is a coating having a thickness of less than about 600 μm.

22. The thermochromic composition of claim 2 applied as a coating on a substrate.

23. The thermochromic composition of claim 22 wherein said coating is ink receptive.

24. The thermnochromic composition of claims 22 or 23 wherein said coating is continuous.

25. The thermochromic composition of claims 22 or 23 wherein said coating is zone coated with continuous separate lanes.

26. The thermochromic composition of claims 22 or 23 wherein said coating is printed with disrete patched or images.

27. The thermnochromic composition of claim 22 wherein said coating is applied to the underside of a clear film.

28. The thermochromic composition of claims 22 or 23 wherein said coating is protected by a clear layer.

29. The thermochromic composition of claim 28 wherein said clear layer is a film laminated over said coating.

30. The thermochromic composition of claim 1 formed as an extrudate.

31. The thermochromic composition of claim 30 wherein the amount of thermochromic dye/stabilizer in said extrudate ranges from between about 0.01% and 60% by weight.

32. The thermochromic composition of claim 1 incorporated as a component of a hologram.
